(19) United States
(12) Patent Application Publication
(10) Pub. No.: US 2025/0356512 A1
(43) Pub. Date: Nov. 20, 2025

(54) SYSTEMS, METHODS, AND COMPUTER-READABLE MEDIA FOR ELECTONIC ALIGNMENT IN VOLUMETRIC ADDITIVE MANUFACTURING

(71) Applicant: THE REGENTS OF THE UNIVERSITY OF COLORADO, A BODY CORPORATE, Denver, CO (US)

(72) Inventors: Robert R. McLeod, Boulder, CO (US); Gabriel T. Seymour, Lafayette, CO (US)

(21) Appl. No.: 19/211,170

(22) Filed: May 17, 2025

Related U.S. Application Data
(60) Provisional application No. 63/648,868, filed on May 17, 2024.

(51) Int. Cl. G06T 7/33; G03B 21/20

(52) U.S. Cl. CPC G06T 7/344; G03B 21/2046

(57) ABSTRACT

The present disclosure relates to a volumetric additive manufacturing method for generating multiple two-dimensional images of a three-dimensional model for a 3D object. The method involves identifying a projector line on an alignment plane and capturing images of a vial while rotating a rotation stage to which the vial is attached. The captured images are analyzed to determine an axis of rotation and a vial line on the alignment plane. A misalignment shift and angle are calculated based on the projector line, axis of rotation, and vial line. The plurality of 2D images intended for projection by the projector are then modified according to the calculated projector misalignment angle and shift, ensuring accurate alignment and projection for the volumetric additive manufacturing process. Each of the plurality of 2D images is an optimized image to print the 3D object at a respective rotational angle.

### CROSS-REFERENCE TO RELATED APPLICATIONS

This application claims the benefit of and priority to U.S. Provisional Patent Application Ser. No. 63/648,868 filed on May 17, 2024, and entitled “SYSTEMS, METHODS, AND COMPUTER-READABLE MEDIA FOR ELECTRONIC ALIGNMENT IN VOLUMETRIC ADDITIVE MANUFACTURING,” which is expressly incorporated herein by reference in its entirety.

### STATEMENT REGARDING FEDERALLY SPONSORED RESEARCH

This invention was made with government support under grant number 3R01NS118188-03S1 awarded by the National Institutes of Health. The government has certain rights in the invention.

### FIELD

The present disclosure relates generally to systems, methods, and computer-readable media for alignment in volumetric additive manufacturing, and related specifically to systems, methods, and computer-readable media for aligning image sets for a three-dimensional model for a three-dimensional object based on misalignment angle and shift in volumetric additive manufacturing.

### BACKGROUND

Conventional three-dimensional printing technology has been developed in diverse areas with various materials. Due to the limitations that the material has to be ejected from one or more nozzles of a 3D printer form layers, the printing needs to be performed for a substantially long period of time, which might be several hours or longer than a day.

Volumetric additive manufacturing (VAM) has emerged as a promising technique for fabricating complex three-dimensional (3D) objects by projecting two-dimensional (2D) images into a photopolymerizable resin. Traditional approaches in VAM often involve the use of a static projection system where a series of 2D images are sequentially projected to build up the 3D object layer by layer. These methods typically rely on precise alignment of the projection system with the rotation stage to ensure accurate image overlay and object formation. However, achieving and maintaining this alignment can be challenging due to mechanical tolerances and environmental factors, which can lead to misalignment and defects in the final 3D object.

Previous methods have attempted to address alignment issues by employing manual calibration techniques. These techniques often involve iterative adjustments of the projector and rotation stage positions based on visual inspection or trial-and-error methods. While such approaches can improve alignment, they are time-consuming and require skilled operators to achieve satisfactory results. Additionally, manual calibration does not easily accommodate dynamic changes in alignment that may occur during the manufacturing process, leading to potential inaccuracies in the produced objects.

Another approach has been the use of automated systems that incorporate sensors to detect misalignment and adjust the projection parameters accordingly. These systems typically use feedback loops to continuously monitor the alignment and make real-time corrections. While automated systems can enhance precision and reduce the need for manual intervention, they often involve complex hardware setups and sophisticated control algorithms, which can increase the cost and complexity of the VAM system. Furthermore, these systems may still struggle with accurately compensating for both rotational and translational misalignments simultaneously.

However, none of these approaches have provided a comprehensive solution that combines the features described in this disclosure.

### BRIEF SUMMARY

The present disclosure is related to volumetric additive manufacturing (VAM) systems, methods, and computer readable media for generating a three-dimensional (3D) object. Angular and spatial misalignments may be calculated and addressed by adjusting images for a light projector prior to generating the 3D object, thereby increasing accuracy and confidence in the final product from VAM.

In some aspects, the techniques described herein relate to a volumetric additive manufacturing (VAM) method for generating a plurality of two-dimensional (2D) images of a three-dimensional (3D) model for a 3D object, the VAM method including: identifying a projector line of a projector on an alignment plane; capturing images of vial while rotating a rotation stage where the vial is attached; analyzing the images to identify an axis of rotation and a vial line on the alignment plane; calculating a misalignment shift and a misalignment angle based on the projector line, the axis of rotation, and the vial line; and modifying the plurality of 2D images of the 3D model, which are to be projected by the projector, based on the calculated projector misalignment angle and the calculated projector misalignment shift. Each of the plurality of 2D images is an optimized image to print the 3D object at a respective rotational angle.

In some aspects, the techniques described herein relate to a VAM method, wherein the projector is a digital micromirror device or spatial light modulator configured to shape light into a pattern according to the 3D model.

In some aspects, the techniques described herein relate to a VAM method, wherein the projector line is a vertical center line of the projector on the alignment plane.

In some aspects, the techniques described herein relate to a VAM method, wherein the misalignment shift is a lateral distance between the axis of ration and an axis of rotation of the vial.

In some aspects, the techniques described herein relate to a VAM method, wherein the misalignment angle is an angle between the projector line and the axis of rotation.

In some aspects, the techniques described herein relate to a VAM method, further including, in a case where a longitudinal axis of the vial is not parallel with the axis of rotation of the rotation stage, while the rotation stage rotates where the vial is attached: calculating an azimuthal angle of the vial with respect to a vertical axis of the alignment plane and a polar angle of the vial with respect to a horizontal axis of the alignment plane.

In some aspects, the techniques described herein relate to a VAM method, wherein modifying the plurality of 2D images is performed after tilting the 3D model of the 3D object to match the azimuthal angle of the vial.

In some aspects, the techniques described herein relate to a VAM method, wherein an angle, β, between the projector line and the vial line is calculated by the following equation at an angle, α, at a rotation of the rotation shaft: β=−tan⁻¹(tan(ϕ)·sin(α−θ))+θ_{proj,AOR}, Where is the azimuthal angle, is the polar angle, and is the angle between the projector line and the axis of rotation.

In some aspects, the techniques described herein relate to a VAM method, wherein modifying the plurality of 2D images is performed by rotating the plurality of 2D images based on the calculated projector misalignment angle.

In some aspects, the techniques described herein relate to a VAM method, wherein modifying the plurality of 2D images is performed by shifting the plurality of 2D images based on the calculated projector misalignment shift.

In some aspects, the techniques described herein relate to a volumetric additive manufacturing (VAM) system for generating a three-dimensional (3D) object, the VAM system including: a projector configured to project light to cure a liquid contained in a vial to generate the 3D object based on a plurality of two-dimensional (2D) images of a 3D model of the 3D object; a rotation stage configured to rotate the vial; an image capturing device configured to capture images of the vial, while the rotation stage rotates; a processor configured to: identify a projector line on an alignment plane; capture images of vial while rotating a rotation stage where the vial is attached; analyze the images to identify an axis of rotation and a vial line on the alignment plane; calculate a misalignment shift and a misalignment angle based on the projector line, the axis of rotation, and the vial line; and modify the plurality of 2D images of the 3D model based on the calculated projector misalignment angle and the calculated projector misalignment shift. Each of the plurality of 2D images is an optimized image to print the 3D object at a respective rotational angle.

In some aspects, the techniques described herein relate to a VAM system, wherein the projector is a digital micromirror device configured to shape light into a pattern according to the 3D model.

In some aspects, the techniques described herein relate to a VAM system, wherein the projector line is an optical axis of the projector on the alignment plane.

In some aspects, the techniques described herein relate to a VAM system, wherein the misalignment shift is a lateral distance between the axis of ration and an axis of rotation of the vial.

In some aspects, the techniques described herein relate to a VAM system, wherein the misalignment angle is an angle between the projector line and the axis of rotation.

In some aspects, the techniques described herein relate to a VAM system, further including, in a case where a longitudinal axis of the vial is not parallel with the axis of rotation of the rotation stage, while the rotation stage rotates where the vial is attached: calculating an azimuthal angle of the vial with respect to a vertical axis of the alignment plane and a polar angle of the vial with respect to a horizontal axis of the alignment plane.

In some aspects, the techniques described herein relate to a VAM system, wherein modifying the plurality of 2D images is performed after tilting the 3D model of the 3D object to match the azimuthal angle of the vial.

In some aspects, the techniques described herein relate to a VAM system, wherein an angle, β, between the projector line and the vial line is calculated by the following equation at an angle, α, at a rotation of the rotation shaft: β=−tan⁻¹(tan(ϕ)·sin(α−θ))+θ_{proj,AOR}, wherein is the azimuthal angle, is the polar angle, and is the angle between the projector line and the axis of rotation.

In some aspects, the techniques described herein relate to a VAM system, wherein modifying the plurality of 2D images is performed by rotating the plurality of 2D images based on the calculated projector misalignment angle.

In some aspects, the techniques described herein relate to a nontransitory computer-readable medium storing instructions that, when executed by a computer, cause the computer to perform a volumetric additive manufacturing (VAM) method for generating a plurality of two-dimensional (2D) images of a three-dimensional (3D) model for a 3D object, the VAM method including: identifying a projector line of a projector on an alignment plane; capturing images of vial while rotating a rotation stage where the vial is attached; analyzing the images to identify an axis of rotation and a vial line on the alignment plane; calculating a misalignment shift and a misalignment angle based on based on the projector line, the axis of rotation, and the vial line; and modifying the plurality of 2D images of the 3D model, which are to be projected by the projector, based on the calculated projector misalignment angle and the calculated projector misalignment shift. Each of the plurality of 2D images is an optimized image to print the 3D object at a respective rotational angle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which at least some of the advantages and features of the present disclosure may be obtained, a more particular description of aspects of the present disclosure will be rendered by reference to specific aspects thereof which are illustrated in the appended drawings. Understanding that these drawings depict only typical aspects of the present disclosure and are not therefore to be considered to be limiting of its scope, aspects of the present disclosure will be described and explained with additional specificity and detail through the use of the accompanying drawings.

FIG. 1 illustrates a graphical schematic of a volumetric additive manufacturing system according to various aspects of the present disclosure;

FIG. 2 illustrates a graphical schematic of a volumetric additive manufacturing system according to various aspects of the present disclosure;

FIG. 3A illustrates a graphical schematic for identifying a projector line of a projector according to various aspects of the present disclosure;

FIG. 3B illustrates a graphical schematic for identifying walls of a vial of a volumetric additive manufacturing system according to various aspects of the present disclosure;

FIG. 3C illustrates a graphical schematic for identifying a vial line with respect to an axis of rotation according to various aspects of the present disclosure;

FIG. 4A illustrates a graphical schematic of a projector spatial misalignment with respect to an axis of rotation according to various aspects of the present disclosure;

FIG. 4B illustrates graphical representations of objects generated by a volumetric additive manufacturing system with multiple vial spatial misalignments according to various aspects of the present disclosure;

FIG. 5A illustrates a graphical schematic of a projector angular misalignment with respect to an axis of rotation according to various aspects of the present disclosure;

FIG. 5B illustrates graphical representations of objects generated by a volumetric additive manufacturing system with multiple projector angular misalignments according to various aspects of the present disclosure;

FIG. 6A illustrates a graphical schematic of misalignment conditions among an axis of rotation, the projector line, and the vial line according to various aspects of the present disclosure;

FIG. 6B illustrates a graphical schematic after correction of the misalignment conditions according to various aspects of the present disclosure;

FIG. 7A illustrates a graphical representation showing misalignments of a vial according to various aspects of the present disclosure;

FIG. 7B illustrates a coordinate schematic showing azimuthal and polar misalignments of a vial according to various aspects of the present disclosure;

FIG. 8A illustrates a graphical representation showing walls of a vial and detected vial lines according to various aspects of the present disclosure;

FIG. 8B illustrates a projector line, detected vial lines, an axis of rotation, and a line perpendicular to the axis of rotation in a graphical representation according to various aspects of the present disclosure;

FIG. 9A illustrate data plots and a fitting curve to identify vial misalignments according to various aspects of present disclosure;

FIG. 9B illustrate data plots and a fitting curve to identify vial misalignments according to various aspects of present disclosure;

FIG. 10 illustrates graphical representations of real output results after corrections of misalignments according to various aspects of present disclosure;

FIG. 11 illustrates a flowchart for correcting spatial and angular misalignments for a volumetric additive system according to various aspects of the present disclosure; and

FIG. 12 illustrates a block diagram of a computing device according to various aspects of present disclosure.

### DETAILED DESCRIPTION

Volumetric additive manufacturing (VAM) systems, methods, and computer-readable media as disclosed herein may be used to adjust angles and shifts to correct misalignment among a vial, a light projector, and a rotational axis of the vial so that the final three dimensional products may be produced with accuracy and confidence. In various aspects, these misalignments may be corrected by compensating for angles and shifts among the vial, the light projector, and the rotational axis of the vial, which are detected by using an image capturing device. Furthermore, instead of mechanically adjusting the angles and shifts among the vial, the light projector, and the rotational axis of the vial, two-dimensional (2D) images of a three-dimensional (3D) model of the final product may be generated and modified based on the angles and shifts. The 2D images are cross sectional images of the 3D model when the 3D model is rotated by respective rotation angles. The light projector emits light according to the modified 2D images, thereby forming the final product within the vial at the desired portion.

The above-disclosed systems and methods may be implemented in a computing device via computer-executable instructions, which comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones tablets, mobile devices, smartphones, PDAs, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

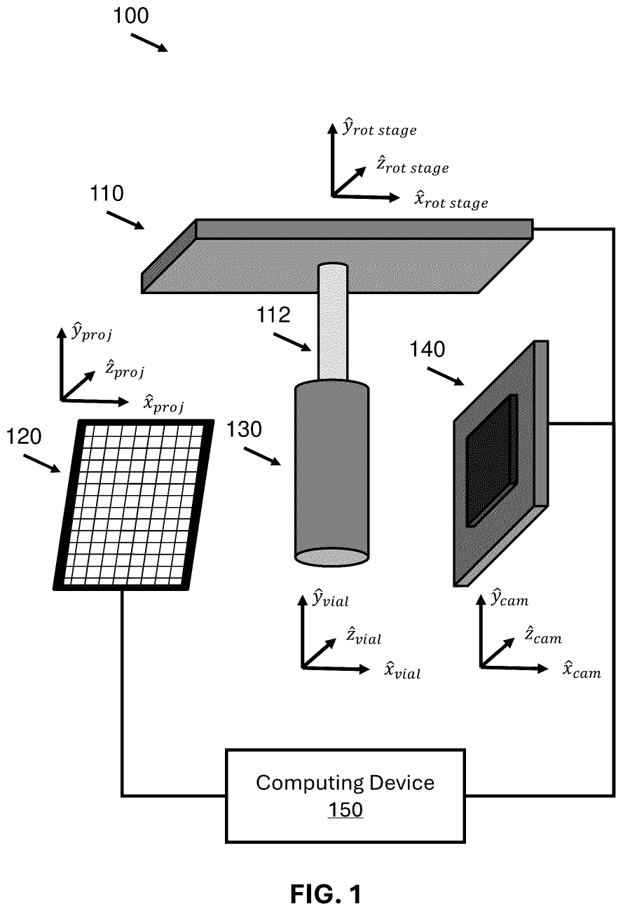

Turning now to FIG. 1, illustrated is a volumetric additive manufacturing system 100 according to various aspects of the present disclosure. The VAM system 100 is an advanced form of 3D printing technology that fabricates entire objects within a volume of photosensitive materials, using light to selectively solidify material in every direction in the three dimension. In other words, the VAM system 100 creates the entire structure of a 3D object simultaneously by projecting light patterns into a rotating container of photosensitive materials. Thereby, the time required to form the 3D object may be decreased compared to the time required by the conventional 3D printing technique, which forms the 3D object layer by layer.

The VAM system 100 may include a rotation stage 110, a light source or projector 120, a vial 130, an image capturing device 140, and a computing device 150. The rotation stage 110 provides structural stability so that a rotation shaft 112 does not wobble or rattle while the rotation shaft 112 rotates. As shown, the rotation stage 110 may have a coordinate system, namely, the rotation stage coordinate system, which includes three perpendicular axes, X_{RT}, Y_{RT}, and Z_{RT}, which may be different from an environment coordinate system. The vial 130 may be mounted to the end portion of the rotation shaft 112. In this regard, the end portion of the rotation stage 110 have a locking mechanism, which firmly locks the vial 130, when the vial 130 mates with the rotation stage 110. After locking the vial 130, when the rotation shaft 112 is rotating along the axis of rotation, the vial 130 is also rotating along the axis of rotation.

In an aspect, the axis of rotation may coincide with the center line of the rotation shaft 112. In an ideal situation, the axis of rotation also coincides with the center line of the vial 130. However, in real life, the center line of the vial 130 does not coincide with the axis of rotation. In this regard, the vial 130 may have its own coordinate system, which has three perpendicular axes, Xᵥᵢₐₗ, Yᵥᵢₐₗ, and Zᵥᵢₐₗ.

The vial 130 may have an inner space, into which a photosensitive material may be inserted. The photosensitive material may be solidified when a corresponding light is illuminated over the photosensitive material. The vial 130 may be made of glass and transparent so that light may pass through the vial 130 to activate the photosensitive material. Further, the vial 130 may have a cylindrical shape so that the light can pass through the same thickness of the wall of the vial 130 to shine the photosensitive material at any direction while the vial 130 rotates. The photosensitive material may be photosensitive resin.

The projector 120 may emit light, which can activate the photosensitive material. The projector 120 may also have its own coordinate system, which has three perpendicular axes, Xₚᵣₒⱼ, Yₚᵣₒⱼ, and Zₚᵣₒⱼ. In aspects, the projector 120 may employ a digital micromirror device (DMD), which includes an array of tiny mirrors that can tilt to reflect light either toward or away from a projection path. Each mirror may correspond to a pixel in a projected image, allowing for high-resolution, grayscale or binary light patterns. In an aspect, the projector 120 may be a spatial light modulator (SLM).

Specifically, when a 3D object is to be formed or printed, a corresponding three-dimensional (3D) model may be generated. Based on the 3D model, a group of two-dimensional (2D) images may be generated off from the 3D model at a group of rotation angles. In other words, each 2D image may be an image specific to one rotation angle of the vial 130. The mirrors of the DMD may be controlled based on the 2D images of the 3D model so that corresponding mirrors may be illuminated to activate specific locations in the photosensitive material contained in the vial 130 so as to print the 3D object within the photosensitive material in the vial 130 at a desired location.

The light may be generated in the ultraviolet (UV) or near-UV range (e.g., 365-405 nm), which matches the absorption spectrum of the photosensitive material by a high-intensity light emitting diode (LED) or laser. The light may be collimated and passed through optics that shape and direct it onto the DMD, which then reflects the modulated light through a projection lens and into the photosensitive material. The frequency range of the light may not be limited to the UV range but may extend outside of the UV range.

In an ideal situation, the coordinate system of the rotation stage 110 matches the coordinate systems of the projector 120. In real life, however, the coordinate system of the rotation stage 110 generally does not match the coordinate system of the projector 120 based on mechanical tolerances and human errors. Thus, any deviation from the matching coordinate systems, which may be either spatial (a shift in position) or angular (a tilt in orientation), can lead to distortions in the printed object. These misalignments may be typically detected using the image capturing device 140 and corrected either mechanically or through software-based image warping over the group of 2D images of the 3D model. Mechanical corrections, however, require expertise and high precision.

With regard to the mismatches between coordinate systems, the vial 130 and the axis of rotation may also have mismatched coordinate systems. For example, the axis of rotation of the rotation shaft 112 may not coincide with the center line or vial line of the vial 130. Specifically, the vial line of the vial 130 may be laterally shifted from the axis of rotation. In addition, the vial line of the vial 130 may not be parallel with the axis of rotation. In these cases, when the rotation shaft 112 rotates, the resulting volume, which the vial 130 generates while rotating, is much different from the shape of the vial 130. Thus, that leads to distortion of the 3D object printed in the photosensitive material contained in the vial 130.

Before the rotation stage 110, the projector 120, and the vial 130 start forming a 3D object, the image capturing device 140 may capture images thereof. Such images may be captured in an alignment plane, which is a virtual plane. The image capturing device 140 may be mounted in a fixed position relative to the projector 120 and the vial 130, and its optical axis may be aligned to intersect the alignment plane. The alignment plane may be a two-dimensional plane, typically defined as the vertical plane, which may be formed by the XY plane and serves as a common optical and spatial reference for the VAM system 100. The alignment plane may be the plane, to which the optical axis of the projector 120 and the optical axis of the image capturing device 140 are to be perpendicular. In this regard, the image capturing device 140 may have its own coordinate system, which has three perpendicular axes, X_{camera}, Y_{camera}, and Z_{camera}. The optical axis of the image capturing device 140 may coincide with the axis of Z+_{camera}.

The image capturing device 140 may be a high-resolution digital camera and may be equipped with a monochrome sensor to maximize sensitivity to the specific wavelength (e.g., the UV or near-UV range) of light used in the VAM system 100.

As described above regarding the coordinate mismatches, the image capturing device 140 may also have mismatches in the coordinate system with those of the rotation stage 110, the projector 120, and the vial 130 based on inaccurate positioning thereof within the VAM system 100.

Now turning to the computing device 150, images captured by the image capturing device 140 may be processed and analyzed by the computing device 150. In this regard, the computing device 150 may be able to control the projector 120 to emit light and the image capturing device 140 to capture images. Further, the computing device 150 may be able to control the rotation stage 110 so that the rotation shaft 112 can rotate at a desired speed and start rotating at a desired time. In an aspect, the computing device 150 may not be able to control the VAM system 100, the rotation stage 110, the projector 120, and the vial 130 but rather receives, processes, and analyzes the captured images from the image capturing device 140. Based on the analysis, the computing device 150 may be able to identify misalignments among them. The misalignments may include a projector spatial misalignment, a projector angular misalignment, a vial spatial misalignment, and a vial angular misalignment. In another aspect, the misalignments may be identified with shadowgrams, which are 2D images that represent the integrated light attenuation through the captured object. These images are used to validate the fidelity of the images by comparing them with simulated shadowgrams generated from the original 3D model of the 3D object to be printed by the VAM system 100.

The projector spatial misalignment is a shift of the projector line from the axis of rotation, when the optical axis of the projector 120 is parallel with the axis of rotation. The shift may be calculated by counting a number of pixels between the projector line of the projector 120 and the axis of rotation in the captured image or shadowgram. The projector angular misalignment may be an angular tilt between the projector 120 and the axis of rotation. The vial spatial misalignment may be calculated by counting a number of pixels between the vial line of the vial 130. The axis of rotation may be determined by analyzing the vial lines in the captured image. The vial angular misalignment may be an angular tilt between the vial 130 and the axis of rotation.

The computing device 150 may be a computer, quantum computer, tablet, smart device, laptop, server, cloud server, processor, application specific integrated circuit (ASIC), or any other electronic device capable of performing image processing.

After identifying these misalignments, the computing device 150 may not mechanically correct them but instead use the computing power to modify the 2D images of the 3D model of the object by shifting and rotating them. Details of image modifications will be further described below.

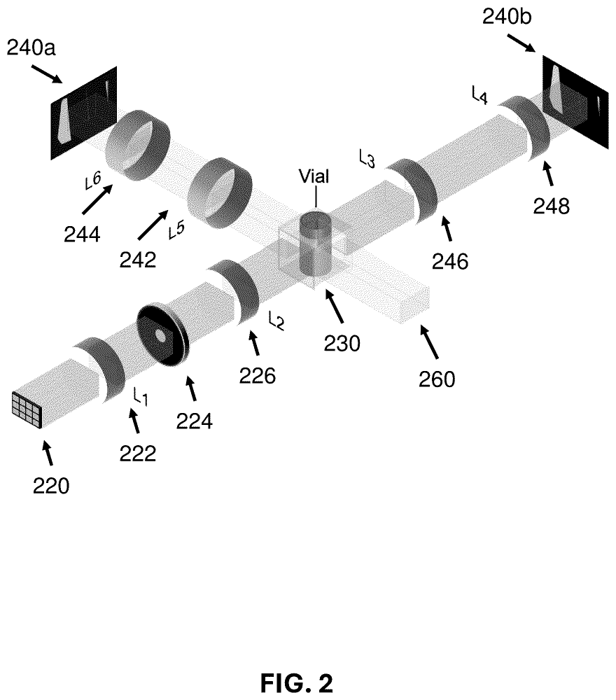

Turning now to FIG. 2, illustrated is a graphical schematic of a volumetric additive manufacturing system showing how to capture images. A digital micromirror device (DMD) 220 may work as a light source together with a light source 260. Each mirror in the DMD 220 may light up so that a corresponding pixel may be captured in a second camera 240b. In this regard, there is a homography between the pixels of the DMD 220 and the pixels in the second camera 240b. The light source 260 may light up so that a vial 230 may light up, correspondingly.

The light source 260 may emit diverging red light, which can illuminate the transparent vial 230 to capture a shadowgram of the vial 230 in a first camera 240a in situ. The shadowgram is a focused image but rather it is a mere shadow. The shadowgram generally shows differences in light intensity. Specifically, the differences in the light intensity are proportional to the second spatial derivative of the refractive index field in the transparent medium. The color or the diverging light may be a color other than the color of DMD 220 so as to differentiate the color of the DMD 220.

Since the optical paths for the DMD 220 and the vial 230 are illustrated differently from each other in FIG. 2, two different cameras may be required. In an aspect, however, the cameras 240a and 240b may be the same camera, which is capable of generating two different images.

Lights emitted by the DMD 220 and the light source 260 are imaged on the same alignment plane and two images may be generated based on the two different colors. In another aspect, one camera may capture two images based on two different frequencies of the lights emitted by the vial 230 and the light source 260.

Between the DMD 220 and the vial 230, there may be a doubly-telecentric imaging system, which includes a lens L1 222, an aperture 224, and a lens L2 226. Likewise, a doubly-telecentric imaging system, which includes a lens L3 246 and a lens L4 248, is placed between the vial 230 and the alignment plane 240b of a camera. An optical system is positioned between the vial 230 and the alignment plane 240a, and includes lens L5 242 and lens L6 244. It is noted that the optical elements, such as lenses and the aperture, are provided as an example and may include less or more than such. Further, the image system is not limited to the doubly-telecentric imaging system but can include any other imaging system which is capable of capturing the above described images.

The camera may also be used to capture images for in situ monitoring or prints within the photosensitive material contained in the vial 230. In an aspect, the vial 230 may be contained in a cuvette. Since the space between the cuvette and the vial 230 can refract the light, the inner space of the cuvette may be filled with an index matched liquid. For example, the index of refraction of the index matched liquid is same as that of the glass of the cuvette and the vial 230, thereby avoiding the light refraction between cuvette and the vial 230. Examples of the index matched liquid are not limited to but may include mineral or immersion oil, glycerol-water mixtures, sucrose-water, solutions2-pyridinemethanol aqueous solutions, silicone oils, cargille index-matching liquids, toluene or benzyl alcohol, and the likes.

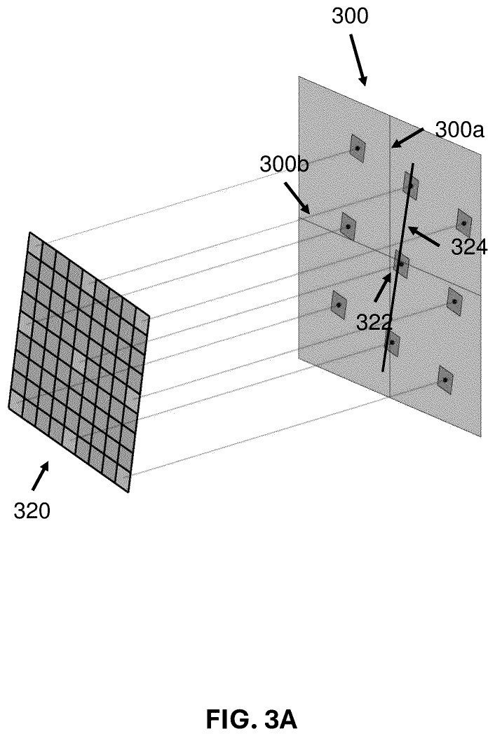

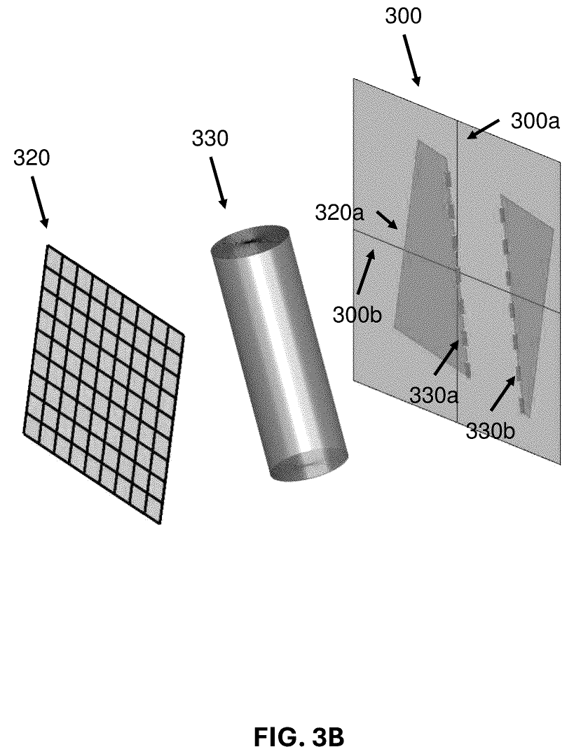

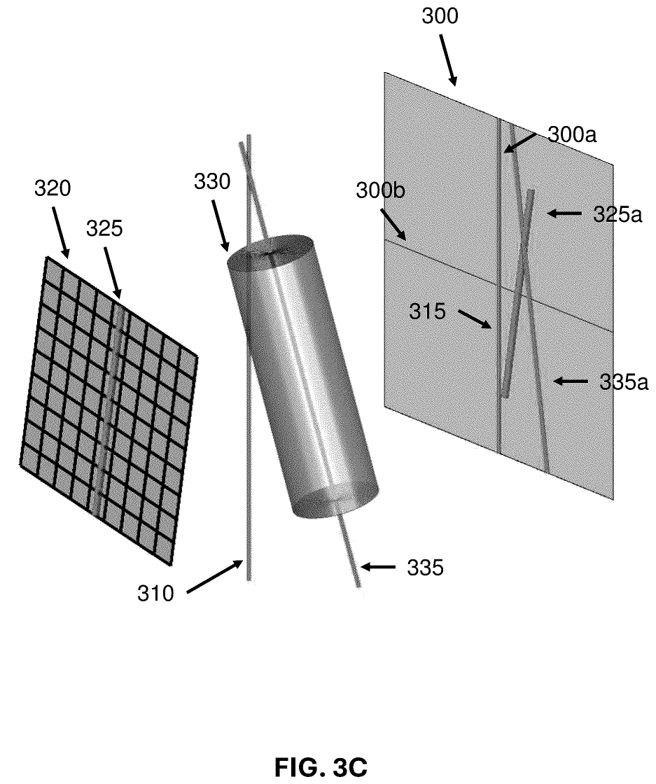

Turning now to FIG. 3A, illustrated is a graphical schematic to show how to identify a projector line of a projector of a volumetric additive manufacturing system. The projector may include a DMD 320, which has a plurality of micro mirrors. When a 3D object is to be printed, a 3D model of the object is generated and cross-sectional 2D images of the 3D model at different rotation angles of a vial are also generated. When the vial is positioned at a specific rotation angle, the corresponding 2D image of the 3D model is provided and the projector may generate a pattern based on the corresponding 2D image. Micro mirrors may be controlled to emit light according to the pattern when the DMD is used.

A camera may capture the resulting pattern on an alignment plane 300. For example, Nine dots are captured on the alignment plane 300. Due to mis-positioning or misalignment, vertical lines and horizontal lines of the nine dots are not parallel with the vertical axis 300a and the horizontal axis 300b of the alignment plane 300. When this error is captured by the camera, a computing device (e.g., the computing device 150 of FIG. 1) may process the image and identify the misalignment.

Specifically, the center of each illuminated region (e.g., the center pixel 322) may be calculated and considered as the center of each pixel. Further, the three pixels in the center form a projector line 324, which corresponds to the center line in the vertical direction in the DMD 320. As illustrated, the projector line 324 is angularly and spatially tilted off from the vertical axis 300a of the alignment plane 300. To correct the projector angular and spatial misalignments, the VAM system does not mechanically rearrange the position and direction of the DMD 320 but rather modify 2D images of the 3D model.

In various aspects, the projector angular misalignment may be measured or calculated by comparing an angle of the projector line 324 with reference to the vertical axis 300a of the alignment plane 300 in the counterclockwise or clockwise direction, and the projector spatial misalignment may be measured or calculated by counting the pixel distance between the vertical axis 300a of the alignment plane 300 and the projector line when the vertical axis 300a and the projector line 324 are arranged to be parallel.

For example, in a case where the projector angular misalignment is a degrees and the projector spatial misalignment is “d” pixel distance, the patterns in the corresponding 2D image may be rotated by −α degrees and then shifted “−d” pixels so that the projector may be able to project the pattern, which fits the coordinate system of the alignment plane 300, when the pattern of the modified 2D image is inputted to the projector. In an aspect, the rotation of the 2D image may be performed with respect to the center pixel 322 of the DMD 320.

After the rotation of the 2D image, the center pixel 322 and the origin of the alignment plane 300 may not align along the vertical axis 300a or the horizontal axis 300b. In such cases, the projector spatial misalignment may be expressed as a paired coordinate, such as (a, b), and may be corrected by shifting the 2D image −a pixels along the horizontal direction and −b pixels along the vertical direction.

FIG. 3B illustrates a graphical schematic for identifying walls of a vial 330 of the volumetric additive manufacturing system. The walls 330a and 330b of the vial 330 are shown along with the boundaries 320a of the DMD 320 in the alignment plane 300. Due to the misalignments between the vial 330 and a rotation stage (e.g., the rotation stage 110 of FIG. 1), which is not shown, the walls 330a and 330b of the vial 330 are not parallel with the vertical axis 300a or the axis of rotation. Further, there are misalignments between the vial 330 and the DMD 320, as well.

In an aspect, the boundaries of the DMD 320 and the walls 330a and 330b of the vial 330 may be simplified to one respective line in the alignment plane 300 so as to simplify the correction operations, as illustrated in FIG. 3C. Within the alignment plane 300, the axis of rotation of the rotating stage is illustrated as an axis of rotation 315, which coincides with the vertical axis 300a, the vertical center line 325 of the DMD 320 is illustrated as a projector line 325, and the center line 335 of the vial 330 is illustrated as a vial line 335a. The vial line 335a may be identified by the center line of the walls 330a and 330b. As illustrated, none of the projector line 325, the vial line 335a, and the axis of rotation 315 are parallel to each other. Thus, without corrections of these misalignments, when the rotation stage rotates, the DMD 320 of the projector cannot activate the photosensitive material at the intended positions within the vial 330. Also, since the vial 330 cannot rotate as designed due to the misalignments with the axis of rotation 315, the DMD 320 of the projector cannot active the photosensitive material at the intended positions even after corrections of the misalignments between the DMD 320 and the axis of rotation 315.

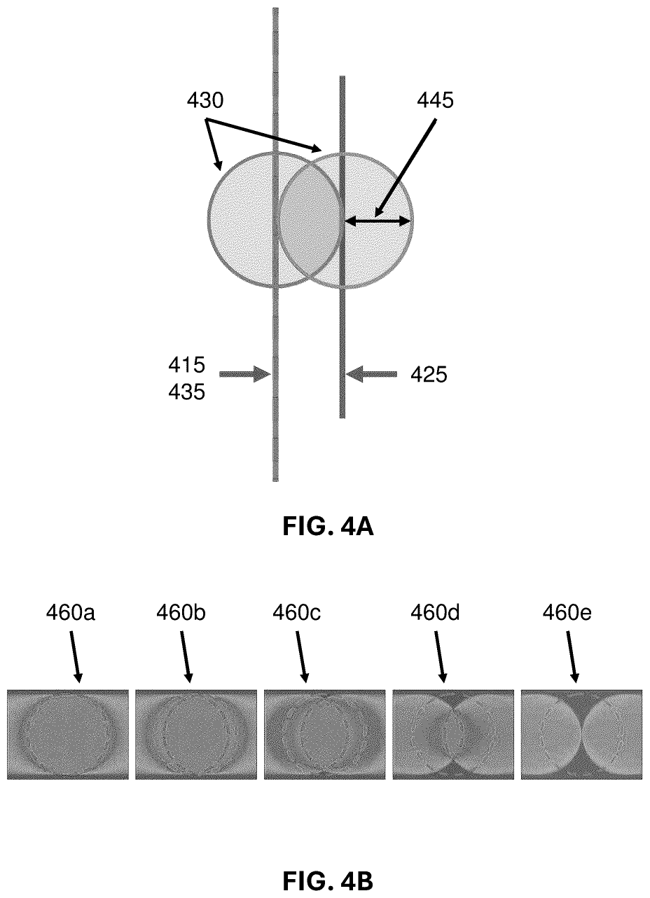

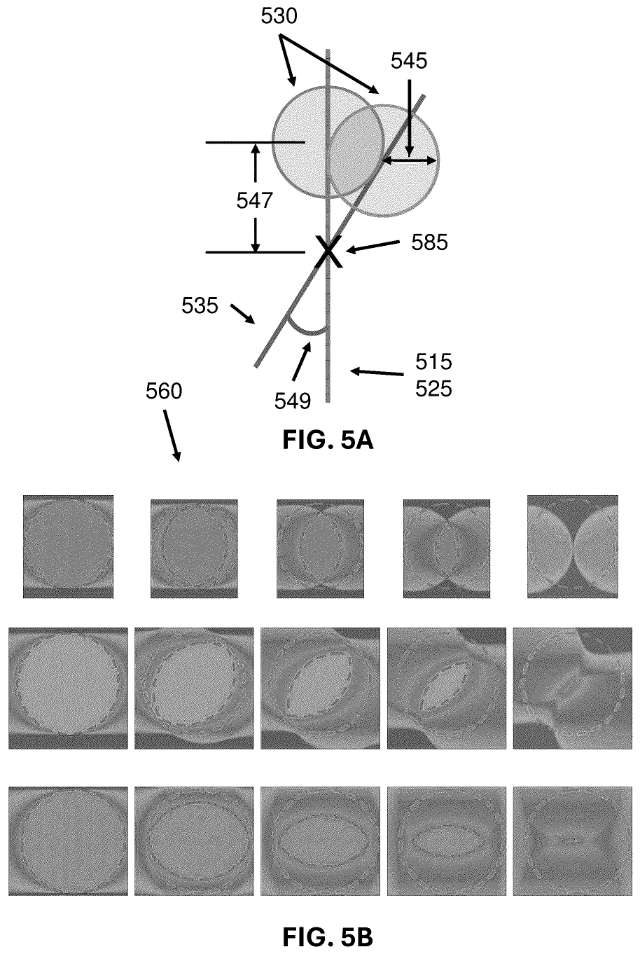

Exemplary output results of the misalignments are illustrated in FIGS. 4A-5B. Specifically, FIG. 4A illustrates a first misalignment type among the misalignments, which is a projector spatial misalignment 445 with respect to an axis of rotation 415. The projector spatial misalignment 445 is represented as Δₚᵣₒⱼ, and the maximum of the projector spatial misalignment is represented as Δ_{proj,max}. In this first misalignment type, the vial line 435 and the axis of rotation 415 coincide with each other, while the projector line 425 is parallel with the axis of rotation 415 but laterally separated by the projector spatial misalignment 445, Δₚᵣₒⱼ. Assuming that the intended object to be printed is a sphere 430, the maximum of the projector spatial misalignment is the radius of the sphere 430, and the photosensitive material within the vial is activated by the light illuminated by the projector.

Since the projector is off from the axis of rotation 415 or the vial line 435, unintended portions of the photosensitive material are illuminated. Differently put, based on the different ratios between the projector spatial misalignment 445 Δₚᵣₒⱼ and the projector spatial misalignment Δ_{proj,max}, namely

$$\frac{{Δ}_{proj}}{{Δ}_{proj , max}} ,$$

different output are generated. For example, potential outputs 460a-460e are illustrated based on different ratios in FIG. 4B. When the ratio is zero, meaning that the axis of rotation 415, the vial line 435, and the projector line 425 coincide with each other, the output 460a is the intended sphere, of which center is located at the center of the vial. The output 460b represents the output when the ratio is 0.25. Likewise, the outputs 460c-460e represent the outputs when the ratios are 0.5, 0.75, and 1, respectively.

In particular, the output 460b shows an egg-shaped output or a vertically-shaped prolate spheroid in the center of the intended sphere 430. The outer part of the vertical prolate spheroid is not formed because the integrated or absorbed intensity of light is lower than the threshold. The output 460e shows that nothing is formed in the intended sphere 430 because nowhere in the space has high enough intensity of light.

FIG. 5A illustrates another first misalignment type of the misalignments, which is a projector angular misalignment 549 with respect to the axis of rotation 515. The projector angular misalignment 549 is represented as θₚᵣₒⱼ, and the maximum of the projector angular misalignment is represented as θₚᵣₒⱼ, max. In this type, the vial line 535 and the axis of rotation 515 coincide with each other, while the projector line 525 is angularly shifted with respect to the axis of rotation 515 by the projector angular misalignment 549, θₚᵣₒⱼ. An intersection point 585 is an intersecting point between the axis of rotation 515 and the projector line 525 in the alignment plane. The distance 547, ρ, represents a distance between the intersection point 585 and the center of the intended sphere 530 and the radius 545 of the intended sphere 530 is Rₛₚₕₑᵣₑ.

The maximum of the projector angular misalignment may be 90° of the sphere 530 of depend from the distance 547, ρ, and the photosensitive material within the vial is activated by the light illuminated by the projector. The first top row shows simulated outputs when the axis of rotation 515 and the projector line 515 coincide with each other while the ratio

$$\frac{{θ}_{proj}}{{θ}_{proj , max}}$$

ranges from 0 to 1. Thus, the simulated outputs in the top row show the same results as 460a-460e of FIG. 4B and the centers thereof are positioned above the intersection point 585 by the distance 547 ρ.

The second row shows simulated outputs when the angle between he axis of rotation 515 and the projector line 515 is 45° while the ratio,

$$\frac{{θ}_{proj}}{{θ}_{proj , max}}$$

ranges from 0 to 1. Thus, the simulated outputs have prolate spheroid shapes, which are generally inclined by 45° with respect to the axis of rotation 515. The center of the simulated outputs is located at a position, ρ*cos(45°, from the intersection point 585.

The third row shows simulated outputs when the angle between he axis of rotation 515 and the projector line 515 is 90° while the ratio,

$$\frac{{θ}_{proj}}{{θ}_{proj , max}}$$

ranges from 0 to 1. Thus, the simulated outputs have prolate spheroid shapes, which are generally perpendicular to the axis of rotation 515. The center of the simulated outputs is located at the intersection point 585.

In an aspect, the maximum angular misalignment may be calculated by the following equation:

$${θ}_{proj , max} = 2 \cdot {sin}^{- 1} ( \frac{{R}_{sphere}}{2 ρ} ) , \qquad ( 1 )$$

where Rₛₚₕₑᵣₑ is the radius of the intended sphere and p is the distance between the intersection point 585 and the center of the simulated output. Similar to the outputs having projector spatial misalignments, as the degree of projector angular misalignment increases, the simulated objects transform from a sphere to a prolate spheroid where the prolate spheroid is printed within the volume of the original intended sphere with an inclination based on θₚᵣₒⱼ with respect to the axis of rotation 515.

While comparing FIGS. 4A and 4B with FIGS. 5A and 5B, the projector spatial alignment does affect the shape of the simulated output but does not affect the location and orientation of the simulated outputs (i.e., the prolate spheroids). In other words, the simulated output is positioned within the intended sphere of the vial. On the other hand, the projector angular misalignment affect not only the shape of the simulated output but also the orientation of the simulated output.

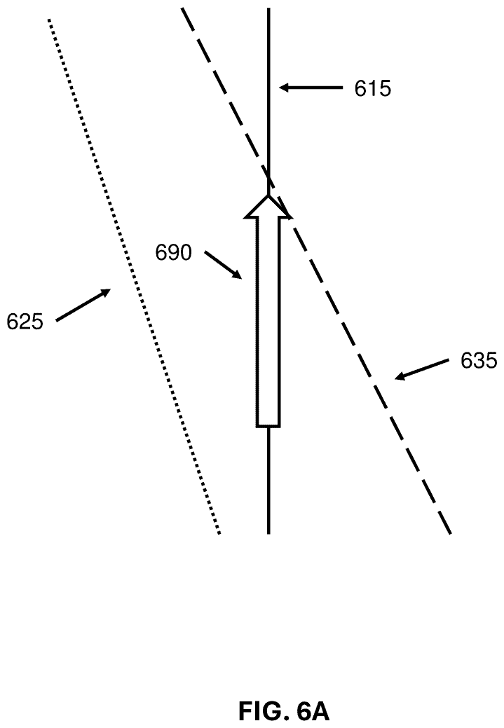

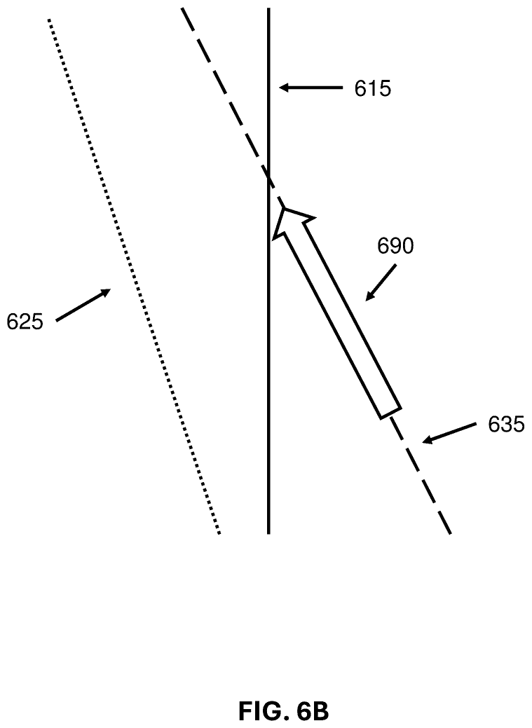

Now turning to FIG. 6A, illustrated is a second misalignment type of the misalignments with respect to an axis of rotation 615. Compared to the misalignments illustrated in FIGS. 4A-5B, FIG. 6A also shows a misalignment of a vial line 635 with respect to a projector line 625 and the axis of rotation 615. As illustrated, the projector line 625 may have a projector spatial misalignment and a projector angular misalignment, and likewise, the vial line 635 may also have a vial spatial misalignment and a vial angular misalignment with respect to the axis of rotation 615. An intended object 690 to be printed is designed to be positioned around the axis of rotation 615. Since the photosensitive material is contained in the vial, the output should also be positioned within the vial. Thus, after the misalignment conditions are addressed, the intended output 690 may be desired to be positioned around the vial line 635 within the vial, as illustrated in FIG. 6B. Specifically, a first type of corrections may be designed to place the intended output within the vial and a second type of corrections may be designed to place the intended output along the vial line.

Again, the mechanical corrections of spatial and angular misalignments of the projector and the vial with respect to the axis of rotation 615 require expertise and careful alignment with high precision, and thus require high costs and times. The present disclosure can address these issues by correcting the 2D images of the 3D model of the intended object according to the misalignments. Thereby, the time to address these issues can be lessened, and high accuracy with avoidance of human errors in mechanical alignments can be provided.

In an aspect, the correction of 2D images may include regenerating a new set of 2D images of the 3D model. The new set of 2D images may include pixel values related to light intensity differences among the pixels.

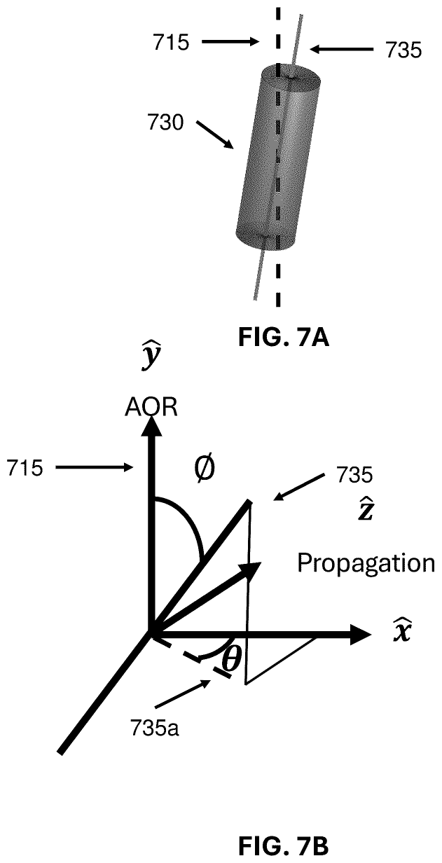

Turning now to FIG. 7A, illustrated is a graphical representation showing misalignments of a vial 730 with respect to an axis of rotation 715 according to various aspects of the present disclosure. Instead of the vial line 635 of FIG. 6A or 6B, a real shape of the vial 730 is a cylindrical shape. A 3D vial line 735 is angularly shifted from the axis of rotation 715 in the 3D coordinate system. A simplified representation of the 3D vial line 735 is illustrated in FIG. 7B within the 3D coordinate system. The axis of rotation 715 coincides with the Y axis of the 3D coordinate system and the alignment plane coincides with the XY plane. Within this coordinate system, the 3D vial line 735 may be represented as a vector.

An angle between the 3D vial line and the axis of rotation is a vial azimuthal angle ϕ, and an angle between a projected line 735a of the 3D vial line 735 to the XZ plane is a vial polar angle, θ from the X axis. Based on the vial polar angle θ and the vial azimuthal angle ϕ, the 3D model of an intended object to be printed may be corrected so that the photosensitive material can print the intended object at the desired position within the vial.

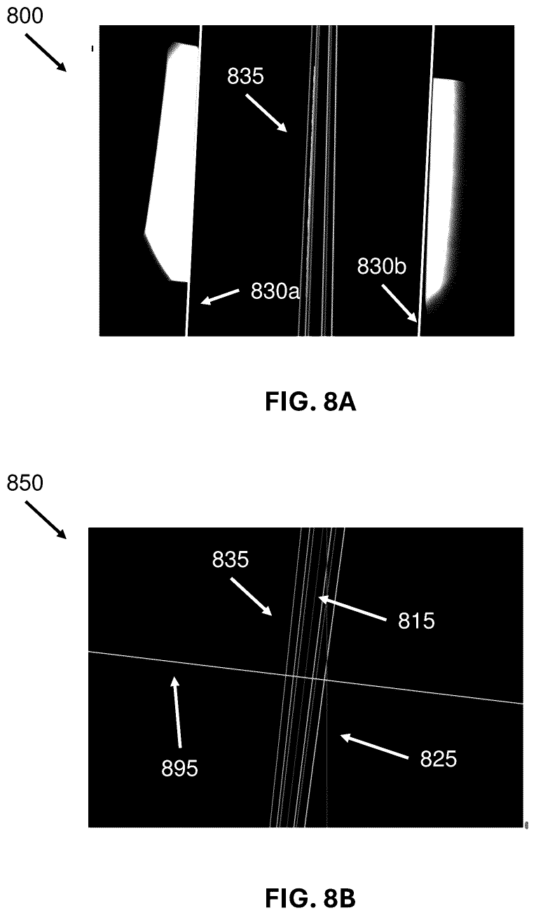

Turning now to FIG. 8A, illustrated is an image 800 of a vial. The walls 830a and 830b of the vial are also illustrated in the image 800. Based on the walls 830a and 830b, the vial line 835 may be estimated by following the center of the walls 830a and 830b. The reason there are several vial lines is that shadowgrams are captured at different rotation angles of the rotation shaft of the rotation stage and the vial lines 835 at different rotation angles are displayed together in the image 800.

As illustrated in FIG. 8B, an axis of rotation 815 is displayed in the image 850 together with the vial lines 835. Further, a projector line 825 is also displayed in the image 850 with the vial lines 835. Furthermore, a line 895 perpendicular to the axis of rotation 815 is also displayed to indicate a position, at which corrections of the misalignments are performed around. Specifically, the intersection point between the line 895 and the axis of rotation 815 is the place to calculate a project spatial misalignment, a distance ρ from the axis of rotation 815 to the vail line 835, a vial azimuthal angle ϕ between the 3D vial line and the axis of rotation 815, and a vial spatial misalignment from the axis of rotation 815.

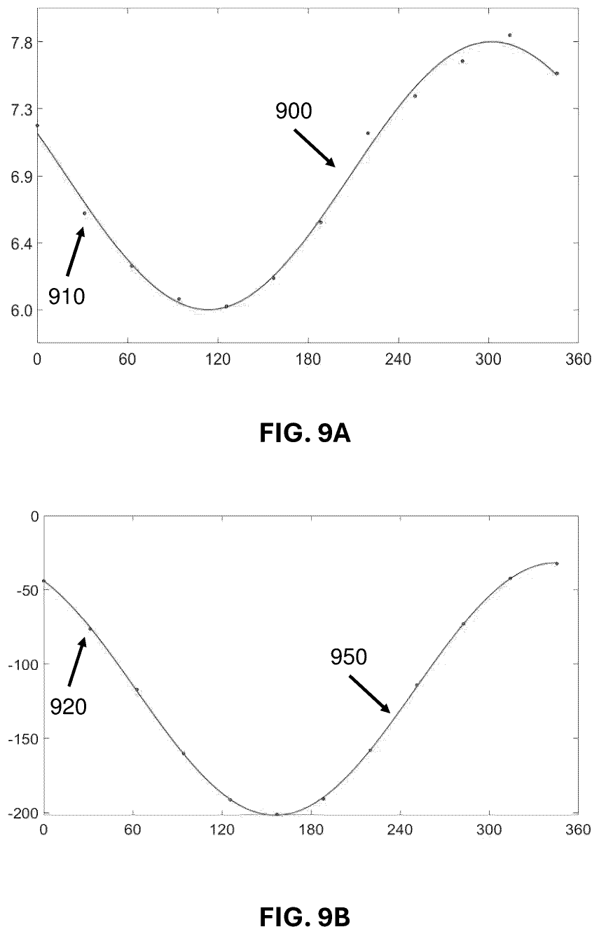

Turning now to FIGS. 9A and 9B, illustrated are a plot 910 showing an angle between the vial line and the axis of rotation in an alignment plane and a plot 920 showing a pixel distance between the vial line and the axis of rotation according to aspects of the present disclosure. As illustrated in FIGS. 8A and 8B, the vial line 835 is angularly tilted from the axis of rotation 815. While the rotation shaft rotates around the axis of rotation, the vial line also rotates. Since the vial line of the vial does not coincide with the axis of rotation, the angle between the vial line and the axis of rotation increases and decreases as the rotation shaft rotates. The plots 910 and 920 show changes in the angle between the vial line and the axis of rotation and in the spatial misalignment, respectively.

The horizontal axis represents the rotation angle of the rotation shaft and the vertical axis represents the amplitude of the angle between the vial line and the axis of rotation. The fit curve 900 may be calculated based on the plot 910. The plot 910 may be obtained by every 30°. The angular distance for detecting the angle may not be limited to 30° but can be less or greater than 30°. Further the angular distance has to be less than 180°. The angular distance may determine an accuracy level of the fit curve 900.

For an explaining purpose, the rotation angle of the vial is defined as α while the angle between the vial line and axis of rotation is defined as β. Since the angle β between the vial line and the axis of rotation is dependent upon the rotation angle α of the vial, the angle β varies and may be defined as β(α). Defining the vial line in the spherical coordinate system with the vial azimuthal angle ϕ, and the vial polar angle θ, the angle β(α) between the vial line and the axis of rotation at an arbitrary rotation angle α may be expressed by the following equation:

$$β ( α ) = - {tan}^{- 1} ( tan ( ϕ ) \cdot sin ( α - θ ) ) . \qquad ( 2 )$$

To derive the equation (2), the projector line may be written as \vec{p}, the axis of rotation may be written as \vec{a}, the vial line may be written as \vec{v}, and the 3D vial line may be written as \vec{V_{3D}}. In the Cartesian coordinate system where the XY plane is the alignment plane, ŷ is coincident and collinear to \vec{a} and \vec{p}, and the origin may be fixed to the midpoint of \vec{p}, and \vec{V_{3D}} may not be contained in the XY plane while \vec{p}, \vec{a}, and \vec{v} are. In this coordinate system, \vec{V_{3D}} may have two angles associated with the axis of rotation, the vial azimuthal angle, ϕ, and the vial polar angle, θ. Two points coincident to \vec{V_{3D}}, p1 and p2, may be defined as

$$p 1 = δ x \hat{x} + δ y \hat{y} + δ z \hat{z} , \qquad ( 3 )$$

$$and$$

$$p \text{} 2 = [ δ x + ρ sin ( ϕ ) sin ( θ ) ] \hat{x} + [ δ y + ρ cos ( ϕ ) ] \hat{y} + [ δ z + ρ sin ( ϕ ) cos ( θ ) ] \hat{z} , \qquad ( 4 )$$

where p2 is defined offset from p1 using the vial azimuthal and polar angles of \vec{V_{3D}} as well as an arbitrary distance between the points, ρ, and \hat{x}, ŷ, and \hat{z} are unit vector for each of X, Y, and Z axes. In an aspect, when Y axis does not coincide with the axis of rotation, ŷ represents the unit vector along the axis of rotation, \hat{x} is a unit vector perpendicular to ŷ in the alignment plane, and \hat{z} is a unit vector perpendicular to the plane formed by x the Rotation of the vial by an angle α transforms these points to

$$p 1 ( α ) = ( δ x \cdot cos α - δ z \cdot sin α ) \hat{x} + ( δ \cdot z cos α + δ x \cdot sin α ) \hat{z} + δ y \hat{y} , \qquad ( 5 )$$

$$and$$

$$\begin{matrix}p 2 ( α ) = [ ( δ x + ρ sin ( ϕ ) sin ( θ ) ) \cdot cos α - ( δ z + ρ sin ( ϕ ) cos ( θ ) ) \cdot sin α ] \hat{x} \\ + [ ( δ z + ρ sin ( ϕ ) cos ( θ ) ) \cdot cos α + ( δ x + ρ sin ( ϕ ) sin ( θ ) ) \cdot sin α ] \hat{z} \\ + [ δ y + ρ cos ( ϕ ) ] \hat{y} .\end{matrix} \qquad ( 6 )$$

Since \vec{v} is the projection of \vec{V_{3D}} to the alignment plane, which is the XY plane in this coordinate system, the projections of these points to the XY plane are coincident to \vec{v}. The angle between these points projected to the XY plane relative to ŷ at a particular rotation angle, β_{\vec{α}}(α), is expressed by the following equation:

$$\begin{matrix}{β}_{\vec{a}} ( α ) = {tan}^{- 1} ( \frac{{p}_{2 , x} - {p}_{1 , x}}{{p}_{2 , y} - {p}_{1 , y}} ) \\ = {tan}^{- 1} ( tan ( ϕ ) \cdot sin ( α - θ ) )\end{matrix} , \qquad ( 7 )$$

where p_{1,x} and p_{1,y} are coordinates of p1 and p_{2,x} and p_{2,y} are coordinates of p2 in the XY plane. The equation (7) may provide the angle of \vec{v} relative to \vec{p} and â for a specific vial angular misalignment (ϕ, θ) at a particular rotation angle, α, in the VAM system only with the vial misalignment.

When these points are defined in the Cartesian coordinate system, ŷ is defined as coincident and collinear to \vec{p}, and \vec{a} is at an angle θ_{\vec{a},\vec{p}} relative to \vec{p}, the expression for the angle β_{\vec{α}}(α) between the points projected to the XY plane relative to \vec{p}(ŷ in this coordinate system) at a particular rotation angle α is

$${β}_{\vec{a}} ( α ) = - {tan}^{- 1} ( tan ( ϕ ) \cdot sin ( α - θ ) ) + {θ}_{\vec{a} , \vec{p}} . \qquad ( 8 )$$

Thus, equation (8) may give the angle β between the vial line and projector line at an arbitrary rotation angle α in the VAM system with vial and projector misalignments. By measuring the angle between the projector line and vial line at multiple rotation angles using the camera and fitting equation (8), the vial angular misalignment and the projector angular misalignment mya be determined with high precision. With the shadowgrams of the vial at varying rotation angles, the amount of spatial misalignment may also be determined.

Since the vial is mechanically coupled to the rotation shaft of the rotation stage, the distance from the vial line to the projector line sinusoidally oscillates while the vial rotates. The distance between the vial line and the projector line, s, is dependent upon the rotation angle α and can be calculated by the following equation:

$$s ( α ) = {Δ}_{vial} \cdot sin ( α - {θ}_{shift} ) + {s}_{proj , AOR} , \qquad ( 9 )$$

where Δᵥᵢₐₗ is the amplitude of the vial spatial misalignment, θ_{shift} is the phase of the vial spatial misalignment, and s_{proj,axis of rotation} is the amount of the projector spatial misalignment. To find the magnitude and phase of the vial spatial misalignment as well as the amount of projector spatial misalignment, the distance between the projector line and vial line may be found for each shadowgram discussed above, and these distances fit to equation (9). By fitting equations (8) and (9) with the angles and distances between the projector line and vial line, respectively, the amount of all four misalignments may be found.

Now turning back to FIG. 9A, based on the fit curve 900 and above equations (2)-(9), the vial azimuthal angle is estimated to be 0.92°, the vial polar angle is estimated to be 18.51°, and the tilt angle of the rotation shaft is estimated to be 6.87° with respect to the axis of rotation.

FIG. 9B illustrates another example of vial angles within an alignment plane. The horizontal axis represents the rotation angles of the rotation shaft, and the vertical axis represents a distance between the vial line and the projector lines in pixels in the shadowgram. The plot 920 may be obtained every 30° rotation angle. The fit curve 950 may be obtained by various methods including non-linear or linearized least squares curve fitting for a trigonometric function. Based on the plot 920, the projector spatial misalignment is measured to be −116.8 pixels, the vial spatial misalignment amount is measured to be −85 pixels, and the vial spatial misalignment phase is measured to be 59°. Based on these pixel distances and the phase, corrections on the 2D images of the 3D model of the intended object may be performed so that the intended object can be printed at the desired location of the photosensitive material contained in the vial.

In various aspects, the corrections may be performed in two steps. The first step is to correct the vial misalignment condition, which include the vial angular misalignment and the vial spatial misalignment, and may be performed on the 3D model of the intended object. More specifically, the first step is performed by tilting the 3D model by the vial azimuthal angle, ϕ, while the axis to tilt is given by the vial polar angle, θ, so as to match the angle of the vial line. In this case, the output results would be aligned with the vial line. If there is no need to align the printed output along the vial line, the first step is not necessary.

After the first step, the second step is performed by correcting the vial spatial, projector spatial, and projector angular misalignments. The projector angular misalignment may be corrected by rotating each 2D image of the 3D model by the angle between the projector line and axis of rotation (e.g., θ_{proj,axis of rotation}), while vial and projector spatial misalignments are corrected by shifting each image along a line perpendicular to the axis of rotation by the pixel distance between the vial line and projector line as expressed in equation (9).

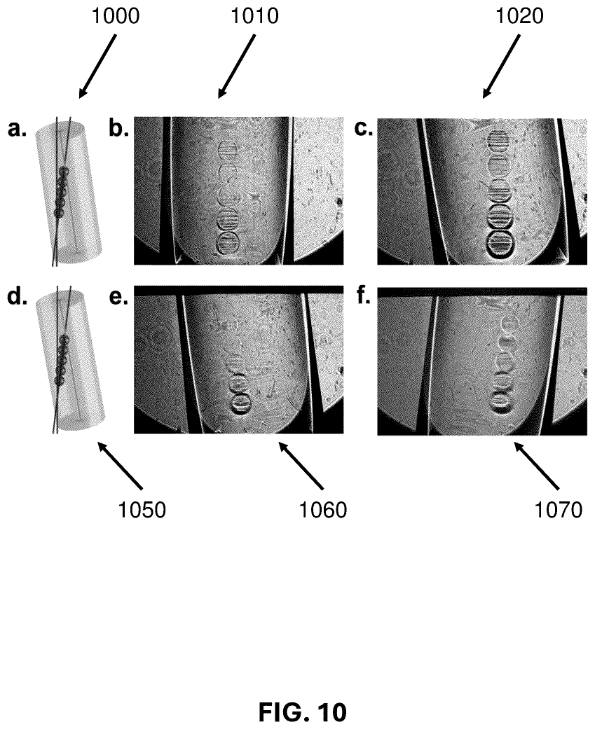

Turning now to FIG. 10, illustrated are graphical representations of real output results of intended objects after corrections of misalignments. Image 1000 shows the intended objects, five spheres along the vial line, and shows that the axis of rotation, the projector line, and the vial line do not coincide with each other. In a case where only the second correction step is performed, the real output results are shown in shadowgrams 1010 and 1020. As illustrated, the five spheres are not aligned with the vial or the vial walls as intended and are shifted from the center of the vial or the vial line in shadowgrams 1010 and 1020.

With the same setup as the image 1000, the image 1050 shows the intended objects, five spheres along the vial line, and shows that the axis of rotation, the projector line, and the vial line do not coincide with each other. Compared to the shadowgrams 1010 and 1020, the shadowgrams 1060 and 1070 show real output results after the first and second types of corrections are performed. As such, the real output results (i.e., the five spheres) align with the vial. In other words, when both the first and second types of corrections are performed, the real output results may align with the vial and may be positioned at the center line (i.e., the vial line) of the vial.

It is noted that the orientation and position of the spheres change with the rotation of the vial. Differences in the appearance of the spheres in the shadowgrams are due to the illumination and imaging systems of the shadowgram system. Additionally, while striations may be visible in the shadowgrams, they may be eliminated using the latent flood cure technique to print striation-free, geometrically accurate objects.

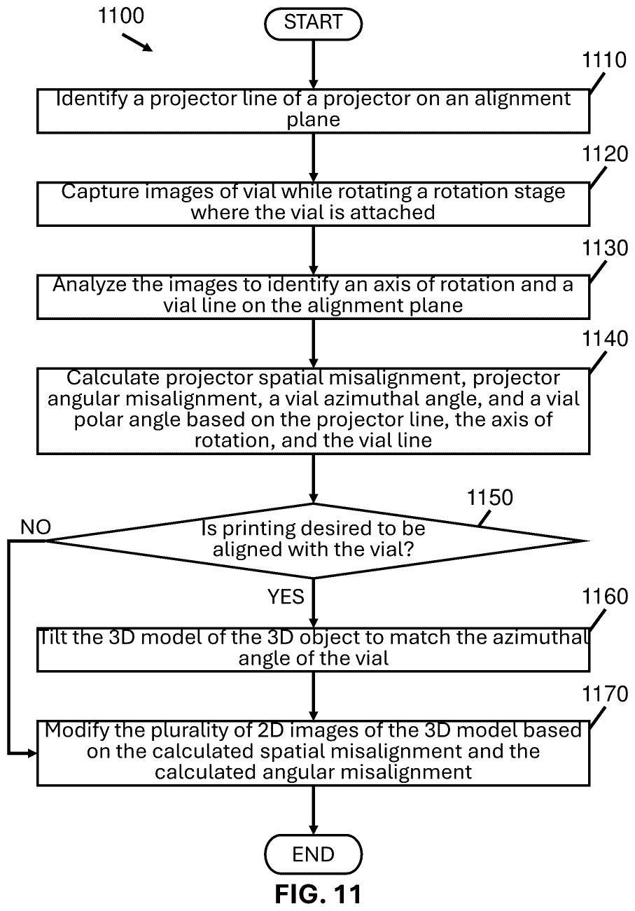

Turning now to FIG. 11, illustrated is a flowchart of a method 1100 for correcting spatial and angular misalignments for a volumetric additive system (VAM) according to various aspects of the present disclosure. The method 1100 can address mechanical misalignments among a rotation stage, a projector, and a vial in the VAM system by modifying 2D images of a 3D model of an object to be printed by the VAM instead of mechanically adjusting the position and orientation thereof. By using a software or algorithm to modify the 2D image, quick corrections could be achieved with high precision in the output results.

The method 1100 may include step 1110, which is performed by identifying a projector line of a projector on an alignment plane. Step 1110 may include taking an image of the projector line on the alignment plane. The projector may include a digital micromirror device (DMD), which includes a 2D array of tiny mirrors that can tilt to reflect light either toward or away from a projection path. Each mirror may correspond to a pixel in a projected image, allowing for high-resolution, grayscale or binary light patterns. The projector line on the alignment plane may correspond to a column of mirrors, which are positioned in the center of the DMD.

The method 1100 may further include step 1120, which is performed by capturing images of the vial while the rotation stage, to which the vial is attached, rotates. The images may be shadowgrams showing the light intensity between boundaries of the vial. The number of the captured images may determine a level of accuracy in detecting misalignments in the VAM system. For example, when one shadowgram is captured at every 30° along a full rotation, 12 total shadowgrams can be captured, and when a shadowgram is captured at every 12°, 30 shadowgrams can be captured.

The method 1100 may further include step 1130, which is performed by analyzing the images to identify an axis of rotation and a vial line on the alignment plane. The misalignment occurs when the axis of rotation, the projector line, and the vial line do not coincide with each other in the alignment plane. The vial line may be determined by finding vertical walls of the vial in the images and detecting the center line, as the vial line, of the vertical walls.

The method 1100 may further include step 1140, which is performed by calculating a projector spatial misalignment, a projector angular misalignment, a vial azimuthal angle, and a vial polar angle based on the projector line, the axis of rotation, and the vial line. Specifically, the projector angular misalignment is the angle between the axis of rotation and the projector line. After the projector angular misalignment is corrected so that the axis of rotation and the projector line become parallel to each other, the projector spatial misalignment is the distance between the axis of rotation and the projector line.

Since the vial rotates according to the rotation of the rotation shaft of the rotation stage, the rotation of the vial may not be stationary in the alignment plane when there is any spatial or angular misalignment therebetween. Thus, the vial lines may change positions and orientations in the shadowgrams. When the angular misalignments between the axis of rotation and the vial lines are plotted and tracked in one full rotation (i.e., a 360° rotation), as shown in FIGS. 9A and 9B, the plot shows a sinusoidal pattern, meaning that the plot has regular increasing and decreasing patterns of the angular misalignments. Thus, a fitting curve (e.g., the curve 900 and 950 of FIGS. 9A and 9B, respectively) may be found based on the regular increasing and decreasing patterns. Based on the fitting curve, the projector spatial misalignment from the axis of rotation, the vial spatial misalignment, and the vial angular misalignment may be detected. Further, pixel distances between the axis of rotation and the projector line and between the axis of rotation and the vial line can be identified in the images.

The vial azimuthal angle ϕ may be an angle between the axis of rotation and the vial line. Even though the vial azimuthal angle ϕ stays the same during the rotation, the angle between the axis of rotation and the vial line may vary in the captured images during the rotation. Thus, based on the regular increasing and decreasing patterns in the plot, the vial azimuthal angle ϕ can be found.

The vial polar angle θ is an angle between the horizontal axis when the vial line is projected on the XZ plane. As the vial rotates, the vial polar angle θ also varies. When the vial polar angle θ becomes 0°, the magnitude of the vial azimuth angle ϕ becomes the greatest. In an aspect, the rotation angle of the vial, when the polar angle θ becomes 0°, may be an optimum angle, at which the projector may print the corresponding 2D image. In this regard, the rotation stage may start rotating at a predetermined angle before the optimum angle. The predetermined angle may be less than or equal to 1 radian (i.e., about) 57.296° before the optimum angle.

The vial azimuthal angle ϕ and the vial polar angle θ are included in the vial misalignment. Based on the vial azimuthal angle ϕ and the vial polar angle θ, the vial angular misalignment and the vial spatial misalignment can be identified.

The method 1100 may further include step 1150, which is performed by determining whether or not the printed object is desired to be aligned with the vial line. In a case where it is determined that the printing is not desired to be aligned with the vial line by a user, the shadowgrams 1010 and 1020, for example, may be formed.

Further in this case, only the first type of correction may be performed for the projector line. In this regard, the method 1100 may further include step 1170, which is performed by modifying the plurality of 2D images of the 3D model based on the calculated projector misalignment angle and the calculated projector misalignment shift. In particular, the plurality of 2D images are rotated to compensate for the projector angular misalignment. The center of the rotations may be the intersecting point between the axis of rotation and the projector line in the captured images or shadowgrams. After the rotations, the axis of rotation and the projector line become parallel to each other and the 2D images are shifted to compensate for the projector spatial misalignment by the pixel distance between the axis of rotation and the projector line.

In a case where it is determined that the printed object is not desired to be aligned with the vial line by the user, the second type of correction may be performed for the vial line. In this regard, the method 1100 may further include step 1160, which may be performed by tilting or rotating the 3D model of the 3D object to compensate for or match the vial azimuthal angle ϕ. Due to the rotation of the 3D model, a new set of 2D images should be generated based on the titled 3D model. This is the second type of corrections, with which, the output results may be printed within the photosensitive material and centered with respect to the vial line.

Then, the method further includes step 1170, which may be performed by modifying the plurality of 2D images of the 3D model based on the calculated projector spatial misalignment and the calculated projector angular misalignment. This is the first type of correction.

By performing the first and second types of corrections, no mechanical alignments are needed and the intended 3D object can be printed at the desired position within the vial even with vial and projector misalignments.

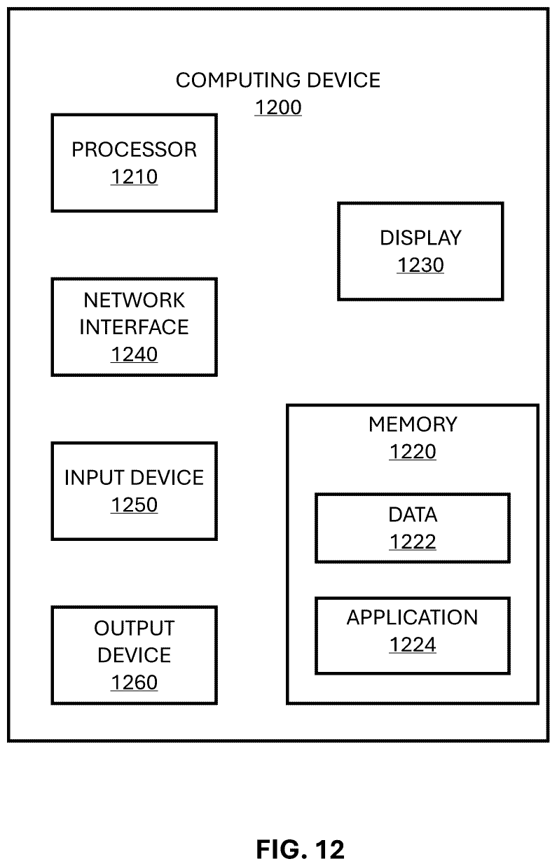

Turning now to FIG. 12, illustrated is a special purpose or general-purpose computing device 1200 including computer hardware, as discussed in greater detail below. The computing device 1200 may be a laptop or desktop computer, server, edge computer, or cloud computer, which can perform any functions, methods, processes disclosed above. The computing device 1200 may include a processor 1210, a memory 1220, a display 1230, a network interface 1240, an input device 1250, and/or an output device 1260. The memory 1220 includes any non-transitory computer-readable storage media for storing data and/or software that is executable by the processor 1210 and which controls the operation of the computing device 1200.

The computing device 1200 may include an operating system configured to perform executable instructions. The operating system is, for example, software, including programs and data, which manages hardware of the disclosed apparatus and provides services for execution of applications for use with the disclosed apparatus. Those of skill in the art will recognize that suitable operating systems include, by way of non-limiting examples, FreeBSD®, OpenBSD, NetBSD®, Linux®, Unix®, Apple® Mac OS X Server®, Oracle® Solaris®, Windows Server®, Windows®, Novell®, NetWare®, iOS®, Android®, or any other operating system readily available. In some aspects, the operating system is provided by cloud computing.

The processor 1210 may be a general purpose processor, a specialized graphics processing unit (GPU) configured to perform specific graphics processing tasks (e.g., parallel processing for training and testing detection and correction of vial and projector misalignments) while freeing up the general-purpose processor to perform other tasks, and/or any number or combination of such processors, digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

The memory 1220 may include one or more solid-state storage devices such as flash memory chips. Alternatively or in addition to the one or more solid-state storage devices, the memory 1220 may include one or more mass storage devices connected to the processor 1210 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 1210. That is, computer readable storage media may include non-transitory, volatile and non-volatile, removable and non-removable media implemented in any method or technology for storage of information such as computer-readable instructions, data structures, program modules or other data. For example, computer-readable storage media includes random access memory (RAM), read-only memory (ROM), erasable programmable read-only memory (EPROM), electrically erasable programmable read-only memory (EEPROM), flash memory or other solid state memory technology, compact disc read-only memory (CD-ROM), digital video disc (DVD), Blu-Ray or other optical storage, magnetic cassettes, magnetic tape, magnetic disk storage or other magnetic storage devices, or any other medium which can be used to store the desired information and which can be accessed by the computing device 1200.

The memory 1220 may store application 1224 (e.g., detection and correction of vial and projector misalignments, etc.) and/or data 1222 (e.g., data plots or shadowgrams). The application 1224 may, when executed by processor 1210, cause the display 1230 to present the user interface to provide information to users. The application 1224 may be one or more software programs stored in the memory 1220 and executed by the processor 1210 of the computing device 1200. The application 1224 may be installed directly on the computing device 1200 or via the network interface 1240. The application 1224 may run natively on the computing device 1200, as a web-based application, or any other format known to those skilled in the art.

In an aspect, the application 1224 may include a sequence of process-executable instructions, which can perform any of the herein described methods, programs, algorithms or codes, which are converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C, Delphi, Fortran, Java, JavaScript, python, machine code, operating system command languages, Pascal, Perl, PL1, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The display 1230 may be a cathode ray tube (CRT), a liquid crystal display (LCD), a thin film transistor liquid crystal display (TFT-LCD), and an organic light emitting diode (OLED) display. In certain aspects, the OLED display is a passive-matrix OLED (PMOLED) or active-matrix OLED (AMOLED) display. In aspects, the display 1230 is a plasma display, and a video projector. In various aspects, the display 1230 may be interactive (e.g., having a touch screen or a sensor such as a camera, a 3D sensor, etc.) that can detect user interactions/gestures/responses and the like so as to serve as both an input and output device.

The network interface 1240 may be configured to connect to a network such as a local area network (LAN) consisting of a wired network and/or a wireless network, a wide area network (WAN), a wireless mobile network, a Bluetooth network, and/or the internet.

For example, the computing device 1200 may process shadowgrams captured by an image capturing device, through the network interface 1240, to identify the projector line, the vial line, and the axis of rotation. The computing device 1200 may update the algorithms, for example, the application 1224, via the network interface 1240. The computing device 1200 may also display processed results and any notification on the display 1230.

The input device 1250 may be any device by means of which a user may interact with the computing device 1200, such as, for example, a mouse, keyboard, touch screen, and/or any other interface. The output device 1260 may include any connectivity port or bus, such as, for example, parallel ports, serial ports, universal serial buses (USB), or any other similar connectivity port known to those skilled in the art.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Computing system functionality can be enhanced by a computing system for ability to be interconnected to other computing systems and power generators via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

The present invention may be embodied in other specific forms without departing from its spirit or characteristics. The described aspects are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A volumetric additive manufacturing (VAM) method for generating a plurality of two-dimensional (2D) images of a three-dimensional (3D) model for a 3D object, the VAM method comprising:
identifying a projector line of a projector on an alignment plane;
capturing images of vial while rotating a rotation stage where the vial is attached;
analyzing the images to identify an axis of rotation and a vial line on the alignment plane;
calculating a misalignment shift and a misalignment angle based on the projector line, the axis of rotation, and the vial line; and
modifying the plurality of 2D images of the 3D model, which are to be projected by the projector, based on the calculated projector misalignment angle and the calculated projector misalignment shift,
wherein each of the plurality of 2D images is an optimized image to print the 3D object at a respective rotational angle.

2. The VAM method according to claim 1, wherein the projector is a digital micromirror device or spatial light modulator configured to shape light into a pattern according to the 3D model.

3. The VAM method according to claim 1, wherein the projector line is a vertical center line of the projector on the alignment plane.

4. The VAM method according to claim 1, wherein the misalignment shift is a lateral distance between the axis of ration and an axis of rotation of the vial.

5. The VAM method according to claim 1, wherein the misalignment angle is an angle between the projector line and the axis of rotation.

6. The VAM method according to claim 1, further comprising, in a case where a longitudinal axis of the vial is not parallel with the axis of rotation of the rotation stage, while the rotation stage rotates where the vial is attached:
calculating an azimuthal angle of the vial with respect to a vertical axis of the alignment plane and a polar angle of the vial with respect to a horizontal axis of the alignment plane.

7. The VAM method according to claim 6, wherein modifying the plurality of 2D images is performed after tilting the 3D model of the 3D object to match the azimuthal angle of the vial.

8. The VAM method according to claim 6, wherein an angle, β, between the projector line and the vial line is calculated by the following equation at an angle, α, at a rotation of the rotation shaft:
$$β = - {tan}^{- 1} ( tan ( ϕ ) \cdot sin ( α - θ ) ) + {θ}_{proj , AOR} ,$$
where ϕ is the azimuthal angle, θ is the polar angle, and θ_{proj,AOR} is the angle between the projector line and the axis of rotation.

9. The VAM method according to claim 1, wherein modifying the plurality of 2D images is performed by rotating the plurality of 2D images based on the calculated projector misalignment angle.

10. The VAM method according to claim 1, wherein modifying the plurality of 2D images is performed by shifting the plurality of 2D images based on the calculated projector misalignment shift.

11. A volumetric additive manufacturing (VAM) system for generating a three-dimensional (3D) object, the VAM system comprising:
a projector configured to project light to cure a liquid contained in a vial to generate the 3D object based on a plurality of two-dimensional (2D) images of a 3D model of the 3D object;
a rotation stage configured to rotate the vial;
an image capturing device configured to capture images of the vial, while the rotation stage rotates;
a processor configured to:
identify a projector line on an alignment plane;
capture images of vial while rotating a rotation stage where the vial is attached;
analyze the images to identify an axis of rotation and a vial line on the alignment plane;
calculate a misalignment shift and a misalignment angle based on the projector line, the axis of rotation, and the vial line; and
modify the plurality of 2D images of the 3D model based on the calculated projector misalignment angle and the calculated projector misalignment shift,
wherein each of the plurality of 2D images is an optimized image to print the 3D object at a respective rotational angle.

12. The VAM system according to claim 11, wherein the projector is a digital micromirror device or spatial light modulator configured to shape light into a pattern according to the 3D model.

13. The VAM system according to claim 11, wherein the projector line is a vertical center line of the projector on the alignment plane.

14. The VAM system according to claim 11, wherein the misalignment shift is a lateral distance between the axis of ration and an axis of rotation of the vial.

15. The VAM system according to claim 11, wherein the misalignment angle is an angle between the projector line and the axis of rotation.

16. The VAM system according to claim 11, further comprising, in a case where a longitudinal axis of the vial is not parallel with the axis of rotation of the rotation stage, while the rotation stage rotates where the vial is attached:
calculating an azimuthal angle of the vial with respect to a vertical axis of the alignment plane and a polar angle of the vial with respect to a horizontal axis of the alignment plane.

17. The VAM system according to claim 16, wherein modifying the plurality of 2D images is performed after tilting the 3D model of the 3D object to match the azimuthal angle of the vial.

18. The VAM system according to claim 16, wherein an angle, β, between the projector line and the vial line is calculated by the following equation at an angle, α, at a rotation of the rotation shaft:
$$β = - {tan}^{- 1} ( tan ( ϕ ) \cdot sin ( α - θ ) ) + {θ}_{proj , AOR} ,$$
where ϕ is the azimuthal angle, θ is the polar angle, and θ_{proj,AOR} is the angle between the projector line and the axis of rotation.

19. The VAM system according to claim 11, wherein modifying the plurality of 2D images is performed by rotating the plurality of 2D images based on the calculated projector misalignment angle.

20. A nontransitory computer-readable medium storing instructions that, when executed by a computer, cause the computer to perform a volumetric additive manufacturing (VAM) method for generating a plurality of two-dimensional (2D) images of a three-dimensional (3D) model for a 3D object, the VAM method comprising:
identifying a projector line of a projector on an alignment plane;
capturing images of vial while rotating a rotation stage where the vial is attached;
analyzing the images to identify an axis of rotation and a vial line on the alignment plane;
calculating a misalignment shift and a misalignment angle based on based on the projector line, the axis of rotation, and the vial line; and
modifying the plurality of 2D images of the 3D model, which are to be projected by the projector, based on the calculated projector misalignment angle and the calculated projector misalignment shift,
wherein each of the plurality of 2D images is an optimized image to print the 3D object at a respective rotational angle.
